(19) United States
(12) Patent Application Publication
(10) Pub. No.: US 2021/0262846 A1
(43) Pub. Date: Aug. 26, 2021

(54) METHODS AND APPARATUS FOR A CAPACITIVE SENSOR

(71) Applicant: SEMICONDUCTOR COMPONENTS INDUSTRIES, LLC, Phoenix, AZ (US)

(72) Inventors: Takayasu OTAGAKI, Ota (JP); Kazuyoshi ISHIKAWA, Kumagaya (JP)

(73) Assignee: SEMICONDUCTOR COMPONENTS INDUSTRIES, LLC, Phoenix, AZ (US)

(21) Appl. No.: 16/797,089

(22) Filed: Feb. 21, 2020

(51) Int. Cl. G01F 23/26

(52) U.S. Cl. CPC G01F 23/268; G01F 23/265

(57) ABSTRACT

Various embodiments of the present technology may provide methods and apparatus for a capacitive sensor. The methods and apparatus may provide a pair of capacitive sensors formed along at least one plane of a container to create dual sensing fields. The capacitive sensor provides a first electrode affixed to the container and extending from a lower portion of the container to an upper portion of the container, a second electrode affixed to an upper portion of the container, and a third electrode affixed to a lower portion of the container and spaced a predetermined distance apart from the second electrode.

### BACKGROUND OF THE TECHNOLOGY

Capacitive sensors operate by detecting changes in the capacitance formed between two electrodes, commonly referred to as a transmission electrode and a sense electrode. A sensing circuit can recognize an object and may be configured to determine the location, pressure, direction, speed, and acceleration of the object as it is approaches and/or contacts the capacitive sensor.

Capacitive sensors may also be utilized to detect a volume and/or a level of a substance, such as fluids or powders, within a container. In this application, the sensing circuit detects changes to the capacitance of the capacitive sensor as the level of the substance in the container changes. Capacitive sensors utilized in such applications may provide a more accurate measurement and may be more reliable and less expensive than conventional indicators. The type of substance within the container may impact have an impact on the ability of the capacitive sensor to accurately detect a level of the substance within the container. For example, a liquid substance may cling to the internal surfaces of the container and cause inaccurate readings or generated capacitance.

### SUMMARY OF THE INVENTION

Various embodiments of the present technology may provide methods and apparatus for a capacitive sensor. The methods and apparatus may provide a pair of capacitive sensors formed along at least one plane of a container to create dual sensing fields. The capacitive sensor provides a first electrode affixed to the container and extending from a lower portion of the container to an upper portion of the container, a second electrode affixed to an upper portion of the container, and a third electrode affixed to a lower portion of the container and spaced a predetermined distance apart from the second electrode.

### BRIEF DESCRIPTION OF THE DRAWINGS

A more complete understanding of the present technology may be derived by referring to the detailed description when considered in connection with the following illustrative figures. In the following figures, like reference numbers refer to similar elements and steps throughout the figures.

FIG. 1 illustrates a perspective view of a container used in conjunction with the capacitive sensor system in accordance with an exemplary embodiment of the present technology;

FIG. 2 illustrates a cross-sectional view of the container of FIG. 1 and in accordance with an exemplary embodiment of the present technology;

FIG. 3A illustrates a perspective view of the container of FIG. 1 with a substance level equal to a lower edge of an electrode in accordance with an exemplary embodiment of the present technology;

FIG. 3B illustrates a perspective view of the container of FIG. 1 with a substance level below the lower edge of an electrode in accordance with an exemplary embodiment of the present technology;

FIG. 4 is a graphical representation of a detected change in capacitance corresponding to a change in the amount of substance held in the container in accordance with an exemplary embodiment of the present technology;

FIG. 5A illustrates a perspective view of an alternative electrode arrangement with a substance level below the lower edge of an electrode in accordance with an exemplary embodiment of the present technology;

FIG. 5B illustrates a perspective view of the container of FIG. 5A with a substance level equal to a lower edge of an electrode in accordance with an exemplary embodiment of the present technology;

FIG. 6A illustrates a perspective view of an alternative electrode arrangement with a substance level below the lower edge of an electrode in accordance with an exemplary embodiment of the present technology;

FIG. 6B illustrates a perspective view of the container of FIG. 6A with a substance level equal to a lower edge of an electrode in accordance with an exemplary embodiment of the present technology;

FIG. 7 illustrates a perspective view of an alternative electrode arrangement with a substance level below the lower edge of an electrode in accordance with an exemplary embodiment of the present technology; and

FIG. 8 illustrates a perspective view of an alternative electrode arrangement with a substance level below the lower edge of an electrode in accordance with an exemplary embodiment of the present technology.

### DETAILED DESCRIPTION OF EXEMPLARY EMBODIMENTS

The present technology may be described in terms of functional block components and circuit diagrams. Such functional blocks and circuit diagrams may be realized by any number of components configured to perform the specified functions and achieve the various results. For example, the present technology may employ various types of capacitors, amplifiers, signal converters, switching devices, power sources, and the like, which may carry out a variety of functions. The methods and apparatus for a capacitive sensor according to various aspects of the present technology may operate in conjunction with any suitable system, such as a printer system or any other system that monitors an amount of a substance in a container.

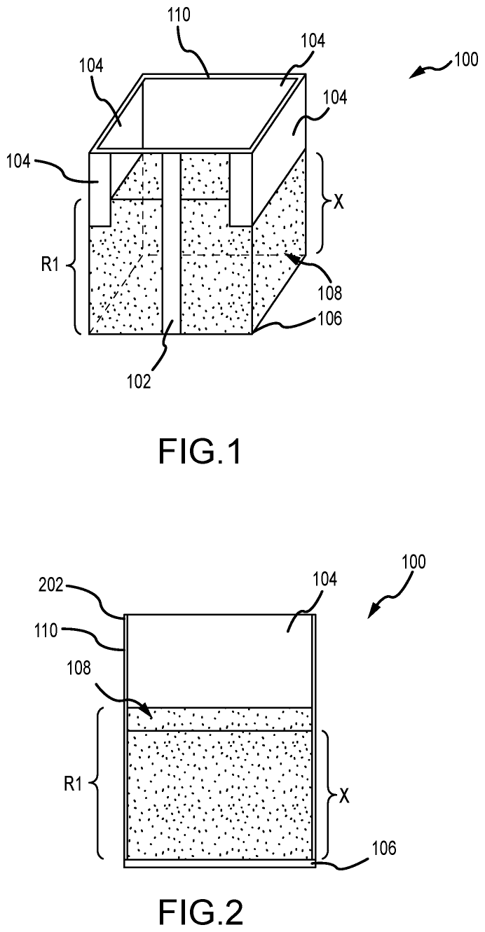

Referring to FIGS. 1 and 2, in various embodiments of the present technology, a capacitance sensor system 100 may detect an amount (or level) of a substance 108, such as a liquid or a powder, stored or otherwise held within a container 110. This may be achieved by positioning, either permanently or temporarily, one or more electrodes to the container 110 to form a pair of capacitive sensors to measure a change in a capacitance and/or an output voltage (Vout) of the capacitance sensor system 100 as the amount of the substance 108 varies in the container 110. In various embodiments, the capacitance sensor system 100 may comprise at least one capacitive sensor and a detection circuit (not shown) that operate in conjunction with each other to measure changes in the capacitance of the capacitive sensors.

The container 110 is used to hold the substance 108 and may comprise any suitable structure or device. For example, the container 1110 may comprise at least one sidewall 202 extending upwardly from a bottom portion to form interior region for holding the substance 108. The container 110 may include a lid or cover to seal off the interior region. The container 110 may further comprise one or more inlet/outlet ports (not shown) positioned near the bottom or top portion that allow for a controlled flow of the substance 108 into or out of the container 110.

The container 110 may be formed into any suitable size or shape and may have dimensions selected according to a desired application. For example, in the case of a rectangular or square-shaped container, a height, a width, and a length may be selected to allow the container 110 to be positioned within a larger device such as a printer, copier, or other like machine. As such, the container 110 may have a maximum volume, equal to a product of the height, the width, and the length (i.e. volume=height×width×length) of the interior region formed. The container 110 may be filled with the substance 108, such as a liquid having with a predetermined dielectric constant, or a powder. Accordingly, the volume of the substance 108 may be computed based on the container dimensions, capacitance data, dielectric constant, and/or other relevant data.

The particular arrangement of the capacitive sensors may be adapted according to a desired sensitivity, function, or application. For example, the size and/or shape of the electrodes may be adapted to be affixed to containers of various shapes and sizes, such as a cylindrical-shaped container having a single sidewall, a spherical-shaped container, a multi-dimensional container having multiple sidewalls, and the like. The electrodes may be positioned on the container 110 by any suitable method such as by being adhesively affixed, mechanically coupled, embedded, or otherwise integrated into a surface of the container 110. In one embodiment, the electrodes may be affixed to an interior surface of one or more sidewalls 202 of the container 110. Alternatively, the electrodes may be positioned along an outer surface of the container 110 and/or integrated within one or more sidewalls 202 of the container 110. In yet another embodiment, the electrodes may be positioned adjacent to the container 110, for example next to, but not in direct contact with, an outer surface of the container 110.

With continued reference to FIGS. 1 and 2, in one embodiment, a first electrode 102 may be positioned along a first vertical sidewall 202 and extend upwardly from a bottom of the container 110 to a top of the container 110. Second electrode 104 may be located along an upper portion of the container 110 and extend along completely along three vertical sidewalls 202 and along a portion of the sidewall 202 that the first electrode 102 is on. The second electrode 104 may cover an edge portion on either side of the first electrode 102 such that there is a distance between side edges of the first electrode 102 and the second electrode 104.

A third electrode 106 may be disposed along a lower portion of the container 110 and be separated from a lower edge of the second electrode by a gap. The gap may be defined by a distance X. A value of X may be determined according to any suitable criteria such as: desired sensitivity, type of substance, desired trigger level of the substance 108 within the container 110, or the like.

The electrodes may be coupled in a manner such that a first capacitance is generated between the first and second electrodes 102, 104 and a second capacitance is generated between the first and third electrodes 102, 106. This connection creates a pair of capacitive sensors within the capacitance sensor system 100. A detection circuit (not shown) may be electrically coupled to each capacitive sensor that is configured to measure changes in the generated capacitance of each capacitive sensor as the amount of substance 108 varies.

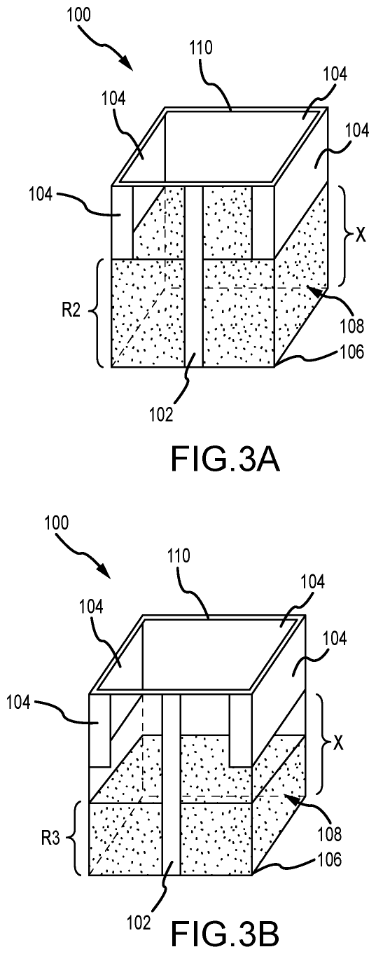

Each capacitive sensor may be positioned to generate an electric field within a given region of the container 110 and operate as a proximity sensor to detect and/or measure changes in the electric field based on an amount of the substance 108 in the container 110. For example, and referring now to FIGS. 1-4, when the substance 108 is in the container and at a level within the area of the second electrode 104 (upper portion of container 110; region R₁), the first and second generated capacitances may indicate that the container 110 is full. As the substance 108 is used and the level within the container 110 falls, the first and second generated capacitances may decrease signaling that the amount of substance 108 left in the container 110 is reducing.

When the level of the substance 108 falls to a level that is equal to the lower edge of the second electrode (FIG. 2) an inflection point in the generated capacitance may be created as the level of the substance 108 falls below the second electrode 104, identified as region R₂. The substance 108 level associated with the inflection point and region R₂ corresponds to the value of X separating the second and third electrodes 104, 106. This is results from a lack of the capacitive sensor associated with the second electrode to sense the substance 108 due to its lack of proximity to the second electrode 104. As the amount of the substance 108 within the container decreases further the generated capacitance detected by the detection circuit may begin to increase, identified as region R₃.

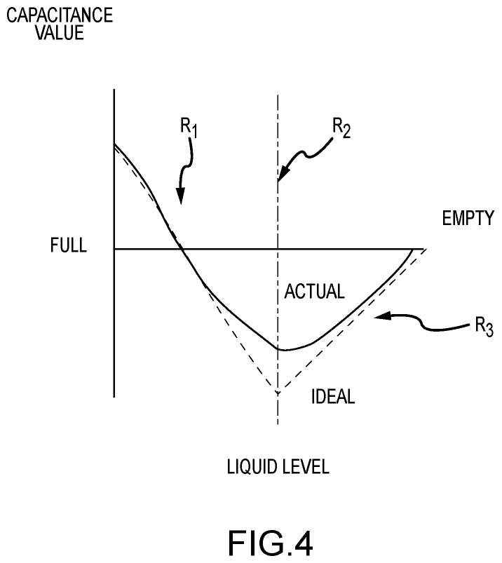

In some instances, the inflection point in the generated capacitance may not occur distinctly at the transition from R₂ to R₃. For example, if the substance 108 comprises a viscous liquid, such as ink, the substance 108 may “cling” to the inner sidewalls of the container 110 resulting in some residual capacitance in R₃. This may cause the inflection point to occur at a location near the transition from R₂ to R₃, such as at a point below the height of X. As shown in FIG. 4, the actual location of the inflection point when the generated capacitance is plotted against the volume of the substance may not be the same as an idealized location. In this situation, the actual inflection point at R₂ and the idealized inflection point at X may not match or be equal to one another. By selecting the desired height of X, the actual and idealized inflections points can be altered or otherwise adjusted according to the properties of the substance 108 filling the container 110.

The first electrode 102 may be configured to operate as a transmission electrode. The second and third electrodes 104, 106 may be configured to operated as either a drive electrode or a ground electrode. For example, the capacitance sensor system 100 may comprise a plurality of switches connected between each capacitive sensor and the detection circuit. Each switch may be selectively operated to connect the first electrode 102 to input terminal Cin and the second and third electrodes 104, 106 to either a drive terminal Cdrv or a ground terminal GND. The electrodes may be formed within an insulation substrate (not shown), such as a PCB substrate, or a flexible plastic substrate (not shown).

The second and third electrodes 104, 106 may be arranged in various structural patterns on the container according to any desired function or application. For example, a particular container 110 may require that the first, second, and third electrodes 102, 104, 106 be arranged along a single layer or sidewall 202. Alternatively, the first, second, and third electrodes 102, 104, 106 may be positioned on such that each electrode is on a single sidewall 202 not shared with another electrode. A feature of any arrangement of electrodes is that the gap X between the second and third electrodes 104, 106 is maintained.

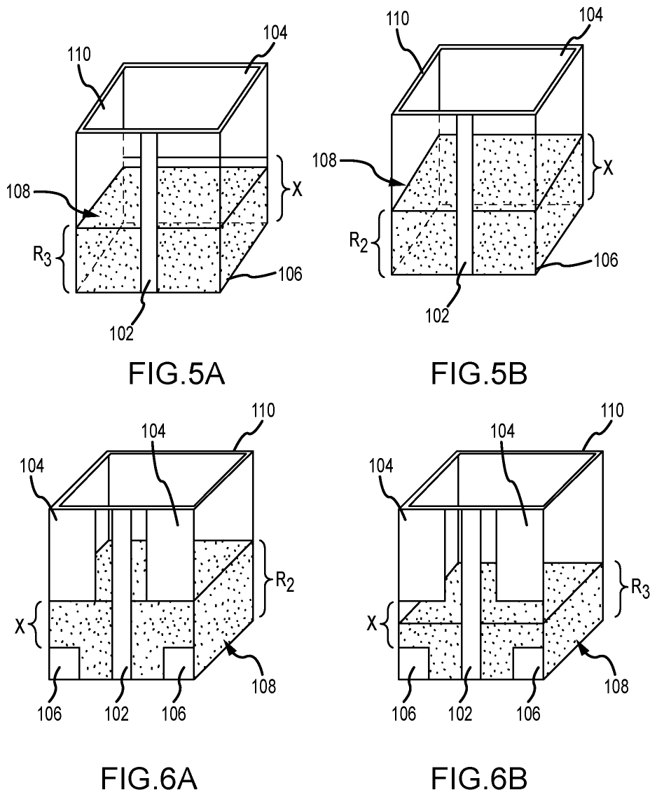

Referring now to FIGS. 5A and 5B, the second electrode 104 may be positioned along the upper portion of a sidewall 202 that is opposite the sidewall 202 that the first electrode 102 is positioned on. The third electrode 106 may be disposed along the entire lower surface of the container such that the lower edge of the second electrode 104 is equidistant from the third electrode at all points by the distance X. This arrangement maintains the ability of the capacitance sensor system 100 to detect the inflection point at region R₂ when the level of the substance 108 in the container 110 is equal to the lower edge of the second electrode 104. As with the embodiment described above, when the level of the substance 108 drops below the lower edge of the second electrode 104 and is within region R₃ (level of the substance is less than X) the rate of change of the generated capacitance changes.

Referring now to FIGS. 6A and 6B, in another embodiment the electrodes may be configured on a single vertical sidewall 202 or plane of the container 110. For example, the second electrode 104 may be positioned along the upper side edge portions of the same sidewall 202 that the first electrode 102 is positioned on. The second electrode 104 may comprise two segments where each segment is positioned in opposing upper side edge portions of the vertical sidewall 202 and is each segment is separated from the first electrode by a gap. The third electrode 106 may also comprise two segments where each segment is positioned in opposing lower side edge portions of the vertical sidewall 202 and is each segment is separated from the first electrode by a second gap. The lower edge of each upper second electrode segment is separated from an upper edge of each lower third electrode segment by the gap X. As described above, the existence of the gap X helps maintain the ability of the capacitance sensor system 100 to detect the inflection point at region R₂ when the level of the substance 108 in the container 110 is equal to the lower edge of each second electrode segment. This arrangement maintains the three regions R₁, R₂, R₃, to identify when the level of the substance 108 drops below the lower edge of the second electrode 104 and the rate of change of the generated capacitance changes.

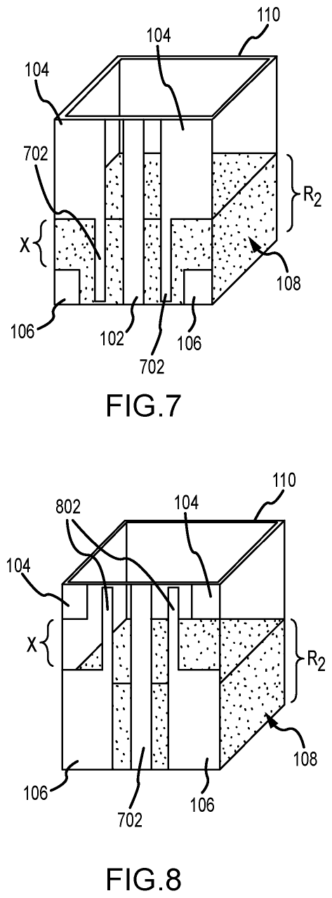

Referring now to FIG. 7, in an alternative embodiment of a single vertical sidewall electrode arrangement, each segment of the second electrode 104 may comprise an extension section 702 that extends downwardly to the lower edge of the container 110. For example, the second electrode 104 may be positioned along the upper side edge portions of the same sidewall 202 that the first electrode 102 is positioned on. The second electrode 104 may comprise two segments where each segment is positioned in opposing upper side edge portions of the vertical sidewall 202 and is each segment is separated from the first electrode by a first gap. Each extension section 702 may extend downwardly adjacent to the first electrode 102.

The third electrode 106 may also comprise two segments where each segment is positioned in opposing lower side edge portions of the vertical sidewall 202 and is each segment is separated from the first electrode by a second gap where one extension section 702 is positioned within the second gap between the third electrode 106 and the first electrode 102. The lower edge of each upper second electrode segment is separated from an upper edge of each lower third electrode segment by the gap X and is separated from the extension section 702 by another gap. Referring now to FIG. 8, in yet another embodiment of a single vertical sidewall electrode arrangement, each segment of the third electrode 104 may comprise an extension section 802 that extends upwardly to the upper edge of the container 110 in the gap between the first electrode 102 and the second electrode 104.

According to various embodiments, the second electrode 104 and the third electrode 106 are separated by the gap X that signifies a constant distance between a lower edge of the second electrode 104 and an upper edge of the third electrode 106. The distance represented by X may comprise any suitable amount and may be determined according to a particular type of container 110 used, substance 108, electrode arrangement, or desired detection level or sensitivity. For example, the gap X may be defined by a distance between of a few millimeters and up to about fifty millimeters. The location or height of the gap X relative to the container 110 may vary. In other words, the first and second electrodes 130, 125 may be positioned such that the gap X extends upwardly from a lower edge of the container 110 or is positioned within a mid-section of the container 110. Alternatively, the gap X may extend downwardly from the upper edge of the container 110 if the second electrode is positioned along just a top surface of the container 110.

In various embodiments, each of the first, second, and third electrodes 102, 104, 106 may comprise a single, continuous conductive element, or a plurality of conductive elements having the same polarity (and referred to collectively as an electrode). For example, each electrode may be formed using any suitable metal and/or other conductive material.

In various embodiments, the strength (density) of the electric field may change based on changes in the position and or shape of the electrodes. For example, and referring to FIGS. 1, 5A, 6A, 7, and 8, as the location of the gap X changes, and corresponding regions R₁, R₂, R₃ change, the rate of change in capacitance (i.e., slope in each region) also changes due to changes in the electric field.

The detection circuit may be coupled to the capacitance sensor system 100 and configured to measure and/or detect changes in the capacitance of the capacitive sensors. The detection circuit may comprise any suitable system or method for sensing changes in capacitance. For example, the detection circuit may comprise an amplifier, an analog-to-digital converter (ADC), and a logic circuit.

According to various embodiments, the detection circuit may be connected to the capacitance sensor system 100 at the input terminal Cin (first electrode) and the drive terminal Cdrv and ground GND terminal (second and third electrodes) either directly or indirectly via the switches.

The detection circuit may be configured to have a preset internal capacitance car a variable internal capacitance. For example, the detection circuit may comprise a variable capacitor with an adjustable capacitance. The detection circuit may further comprise an inverter connected between a power source and the capacitive sensor. The power source may be connected to the capacitive sensor via the drive terminal Cdrv.

The amplifier may be configured to convert the capacitance at the input terminal Cin to a voltage and/or apply a gain the voltage. For example, the amplifier circuit may comprise a differential amplifier comprising an inverting terminal (−) connected to the input terminal Cin and a non-inverting terminal (+) connected to a reference voltage, such as supplied by a voltage source. The amplifier may be configured to measure a voltage difference between the inverting and non-inverting terminals. The amplifier may also be configured to amplify a signal by applying a gain to the voltage difference and generate the output voltage Vout according to the voltage difference and/or the applied gain.

The ADC may be connected to an output terminal of the amplifier and configured to convert the output voltage Vout, to a digital value (i.e., AD value). According to various embodiments, as the capacitance of the capacitive element decreases, the corresponding digital value increases and vice versa. The ADC may comprise any signal converter suitable for converting an analog signal to a digital signal.

The detection circuit may further comprise a first feedback capacitor Cf1 and a second feedback capacitor Cf2. The first feedback capacitor Cf1 may be electrically connected between a first output terminal and the inverting input terminal (−) of the amplifier, and the second feedback capacitor Cf2 may be electrically connected between a second output terminal and the non-inverting input terminal (+) of the amplifier. The first and second feedback capacitors Cf1, Cf2 may have the same capacitance. The first and second feedback capacitors Cf1, Cf2 may operate in conjunction with a first switch and a second switch, respectively, to facilitate various operations and gain control of the amplifier.

The logic circuit may receive the digital value from the ADC, interpret the values, and perform an appropriate response and/or produce an appropriate output signal according to the digital value. According to various embodiments, the logic circuit may be configured to perform various computations, such as additional, subtraction, multiplication, and the like. For example, the logic circuit may comprise logic gates and/or other circuitry to perform the desired computations. The logic circuit may utilize the measured capacitance and/or the change in the measured capacitance to determine if the inflection in capacitance has occurred.

In operation, the capacitance sensor system 100 may be utilized to carry out a variety of detection schemes. For example, the capacitance sensor system 100 may detect the presence or absence of an object within a 3-dimensional space, the level of a substance in a container, and/or a volume of a substance in a container.

In various operations, the capacitance sensor system 100 detects the substance 108 by measuring and/or detecting changes in the capacitance and the corresponding output voltage of each capacitive sensor as a result of changes in the electric field generated by each capacitive sensor. In general, the substance 108 disrupts the each electric field so changes in the amount or the level of the substance 108 in the container 110 will result in changes to the capacitance of each capacitive sensor. As the capacitance changes, the output voltage Vout also changes. As the output voltage Vout changes, it may be possible to quantify or otherwise estimate the amount and/or level of the substance 108 in the container 110 with greater accuracy.

According to one application, the capacitance sensor system 100 may be used in a host device (not shown), such as a printer, and used to monitor levels of ink in an ink cartridge (not shown). For example, the capacitance sensor system 100 may be connected to and communicate with a controller (not shown), such as a microprocessor or other suitable processing circuit, used to control operations of the host device. The controller may utilize information from the capacitance sensor system 100 to determine the level of in the ink cartridge. When the level of ink reaches the inflection point R₂, then the controller may provide an indication, such as displaying a message on the host device or providing a sound indicator (beeping), that the ink may need to be replenished within a short time frame. Similarly, when replenishing the ink, when the ink reaches a particular capacitance within the first region R₁, the controller may provide an indication, such as a displaying a message or providing a sound indicator, that the ink cartridge is full.

According to the present application, the capacitance sensor system 100 is monitoring the capacitance and/or the change in capacitance of each capacitive sensor and determining when an inflection point in the generated capacitance occurs. When the inflection point occurs, the capacitance sensor system 100 may report this event to the controller.

In an alternative application, the capacitance sensor system 100 may be used in a host device to measure a volume of a substance in a container based on the known dimensions (e.g., height, width, length) of the container, the dielectric constant of the substance 108, and the measured capacitance and/or changes in the capacitance and provide a desired feedback accordingly.

The particular implementations shown and described are illustrative of the technology and its best mode and are not intended to otherwise limit the scope of the present technology in any way. Indeed, for the sake of brevity, conventional manufacturing, connection, preparation, and other functional aspects of the system may not be described in detail. Furthermore, the connecting lines shown in the various figures are intended to represent exemplary functional relationships and/or steps between the various elements. Many alternative or additional functional relationships or physical connections may be present in a practical system.

In the foregoing description, the technology has been described with reference to specific exemplary embodiments. Various modifications and changes may be made, however, without departing from the scope of the present technology as set forth. The description and figures are to be regarded in an illustrative manner, rather than a restrictive one and all such modifications are intended to be included within the scope of the present technology. Accordingly, the scope of the technology should be determined by the generic embodiments described and their legal equivalents rather than by merely the specific examples described above. For example, the steps recited in any method or process embodiment may be executed in any appropriate order and are not limited to the explicit order presented in the specific examples. Additionally, the components and/or elements recited in any system embodiment may be combined in a variety of permutations to produce substantially the same result as the present technology and are accordingly not limited to the specific configuration recited in the specific examples.

Benefits, other advantages and solutions to problems have been described above with regard to particular embodiments. Any benefit, advantage, solution to problems or any element that may cause any particular benefit, advantage or solution to occur or to become more pronounced, however, is not to be construed as a critical, required or essential feature or component.

The terms “comprises,” “comprising,” or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present technology, in addition to those not specifically recited, may be varied or otherwise particularly adapted to specific environments, manufacturing specifications, design parameters or other operating requirements without departing from the general principles of the same.

The present technology has been described above with reference to an exemplary embodiment. However, changes and modifications may be made to the exemplary embodiment without departing from the scope of the present technology. These and other changes or modifications are intended to be included within the scope of the present technology.

1. A capacitance sensor for detecting a level of a substance within a container, comprising:
a first electrode extending upwardly along a first vertical sidewall of the container between a bottom of the container and a top of the container;
a second electrode disposed along an upper portion of the container; and
a third electrode disposed along lower portion of the container, wherein:
the second and thirds electrodes are separated from each other by a predetermined vertical distance;
a first capacitance is formed between the first electrode and the second electrode; and
a second capacitance is formed between the first electrode and the third electrode.

2. A capacitance sensor according to claim 1, wherein an inflection point in a rate of change in the first and second capacitances occurs when the level of the substance in the container drops below a lowermost edge of the second electrode.

3. A capacitance sensor according to claim 1, wherein the first electrode comprises a constant width between the bottom of the container and the top of the container.

4. A capacitance sensor according to claim 1, wherein the third electrode is disposed along an entire bottom surface of the container perpendicular to the first electrode.

5. A capacitance sensor according to claim 4, wherein the second electrode is disposed along at least two vertical sidewalls of the container.

6. A capacitance sensor according to claim 5, wherein:
the first electrode extends along a middle portion of the first vertical sidewall; and
the second electrode extends along opposing upper side edge portions of the first vertical wall.

7. A capacitance sensor according to claim 4, wherein the second electrode is disposed along a second vertical sidewall of the container that is opposite the first vertical sidewall.

8. A capacitance sensor according to claim 1, wherein:
the first electrode extends along a middle portion of the first vertical sidewall;
the second electrode comprises two electrode segments, wherein each segment is:
positioned in opposing upper side edge portions of the first vertical wall; and
separated from the first electrode by a first gap;
the third electrode comprises two electrode segments, wherein each segment is:
positioned in opposing lower side edge portions of the first vertical wall; and
separated from the first electrode by a second gap.

9. A capacitance sensor according to claim 8, wherein each segment of the second electrode comprises an extension section that extends from a bottom edge of the segment downwardly to the bottom of the first vertical wall in the second gap formed between the first electrode and the third electrode.

10. A capacitance sensor according to claim 8, wherein each segment of the third electrode comprises an extension section that extends from a top edge of the segment upwardly to the top of the first vertical wall in the first gap formed between the first electrode and the second electrode.

11. A method for detecting a level of a substance in a container using a capacitive sensor, comprising:
positioning a first electrode along a first vertical sidewall of the container wherein the first electrode extends upwardly between a bottom of the container and a top of the container;
positioning a second electrode along an upper portion of the container;
positioning a third electrode disposed along lower portion of the container, wherein the second and thirds electrodes are separated from each other by a predetermined vertical distance;
forming first capacitance between the first electrode and the second electrode;
forming a second capacitance between the first electrode and the third electrode; and
detecting an inflection point in a rate of change in the first and second capacitances according to a height of a surface of the substance.

12. A method according to claim 11, wherein the first electrode comprises a constant width between the bottom of the container and the top of the container.

13. A method according to claim 11, wherein the third electrode is disposed along an entire bottom surface of the container perpendicular to the first electrode.

14. A method according to claim 13, wherein the second electrode is disposed along at least two vertical sidewalls of the container.

15. A method according to claim 14, wherein:
the first electrode extends along a middle portion of the first vertical sidewall; and
the second electrode extends along opposing upper side edge portions of the first vertical wall.

16. A method according to claim 13, wherein the second electrode is disposed along a second vertical sidewall of the container that is opposite the first vertical sidewall.

17. A method according to claim 11, wherein:
the first electrode extends along a middle portion of the first vertical sidewall;
the second electrode comprises two electrode segments, wherein each segment is:
positioned in opposing upper side edge portions of the first vertical wall; and
separated from the first electrode by a first gap;
the third electrode comprises two electrode segments, wherein each segment is:
positioned in opposing lower side edge portions of the first vertical wall; and
separated from the first electrode by a second gap.

18. A method according to claim 17, wherein each segment of the second electrode comprises an extension section that extends from a bottom edge of the segment downwardly to the bottom of the first vertical wall in the second gap formed between the first electrode and the third electrode.

19. A method according to claim 17, wherein each segment of the third electrode comprises an extension section that extends from a top edge of the segment upwardly to the top of the first vertical wall in the first gap formed between the first electrode and the second electrode.

20. A method according to claim 11, wherein the inflection point occurs when the level of the substance in the container drops below a lowermost edge of the second electrode.
